(19) United States
(12) Patent Application Publication
(10) Pub. No.: US 2004/0267607 A1
(43) Pub. Date: Dec. 30, 2004

(54) Performance assessment system and associated method of interactively presenting assessment driven solution

(75) Inventor: Daniel Maddux, San Antonio, TX (US)

Correspondence Address: OBLON, SPIVAK, MCCLELLAND, MAIER & NEUSTADT, P.C., 1940 DUKE STREET, ALEXANDRIA, VA, 22314, US

(73) Assignee: American Payroll Association, San Antonio, TX

(21) Appl. No.: 10/733,442

(22) Filed: Dec. 12, 2003

Related U.S. Application Data
(60) Provisional application No. 60/494,791, filed on Aug. 14, 2003.
(60) Provisional application No. 60/432,993, filed on Dec. 13, 2002.

(51) Int. Cl. G06F 17/60

(52) U.S. Cl. 705/11

(57) ABSTRACT

A method of administering an assessment is provided, and includes receiving a request for said assessment and presenting a test including a dynamic question derived from an electronic archive. Dynamic questions include a stem question and one of a stem question formula, a stem question range, a stem question variable, and a stem question constant. A method is also provided with a step of providing an assessment and recommendation includes providing a recommendation on the basis of a predetermined recommendation rule, where the predetermined recommendation rule is configured to enable a correlation between an answer or set of answers provided in response to at least one dynamic question and a set of recommendations. Systems employing both methods in hardware and/or software are also provided.

### CROSS REFERENCE TO RELATED APPLICATIONS

The present patent application is related to and claims the benefit of provisional U.S. applications 60/432,993 filed on Dec. 13, 2002, and 60/494,791 filed on Aug. 14, 2003. The entire contents of both provisional U.S. applications 60/432,993 and 60/494,791 are incorporated herein by reference.

### BACKGROUND OF THE INVENTION

1. Field of the Invention

This invention relates to systems, apparatuses, methods, and computer program products relating to a performance assessment system.

The present invention relates to a performance assessment system, and, more particularly, to a knowledge assessment calculator (KAC) for presenting a dynamic question set (herein, “assessment,” or “test”) to a Test Taker to accurately measure the skill level/knowledge of the Test Taker in a particular field (defined, for example, by subject, topic, subtopic), and whereby relevant products or training-based solutions are identified and recommended to an interested party.

Modern business practice dictates members of the workforce maintain an evolving skill set for responding to changing market dynamics, such as regulatory mandates and/or new applications of technology. Such adaptation or re-tooling of the work force is often accomplished through the distribution of educational solutions such as review materials or instructional programs.

For example, in a business organization, payroll professionals must integrate legislative and regulatory changes from federal, state, and local governments, as well as innovative electronic processing technologies, into their workflow on a somewhat regular basis as such become available. In this way, the job of a payroll professional is complex, requiring specialized and advanced study on a continual basis. The skill set of a payroll professional is typically assessed by an exam. To this end, the Certified Payroll Professional (CPP) exam was developed by the American Payroll Association (APA) in 1985 as a method of measuring a payroll professional's knowledge against a defined criteria. When the defined criteria is met, mastery of the body of knowledge is accomplished.

2. Description of the Related Art

FIG. 1 is an example of background art showing a system diagram of an existing online test using static test questions. The system includes a network 11 (e.g. internet and/or an intranet) over which the Test Maker, via the Test Maker terminal 13, and the Test Taker, via the Test Taker terminal 15, can interact with a static test database 17.

FIG. 2 shows an example of a background art system detail diagram. Feature 21 is a Test Presenter. Feature 26 is a Test and Question Editor. The previously identified static test database 17 includes a static questions database 28 and test results database 29. From the perspective of a Test Taker 23, the Test Taker interfaces with this system via the Test Presenter 21, and requests a test which uses static questions served from the static questions database 28. The Test Taker responds to the questions, and these responses are stored in the test results database 29. These results are compared to solutions stored in the static questions database 28, and a score is returned to the Test Taker. In the case of a Test Maker 23, a Test Maker interfaces with the Test and Question Editor 26 to add, edit or delete static questions in the static questions database 28 and to define how the Test Presenter selects questions from the static questions database 28 to form static tests.

FIG. 3 shows an exemplary flowchart of a paper and pencil test administered by a certifying professional organization. At S31, the Test Taker takes an exam and submits responses. Next, the proctor grades the exam S33, and then presents an assessment to the Test Taker S35. Paper and pencil tests are limited in that they often require mailing papers back and forth or travel by the Test Maker and/or Test Taker. In addition, paper and pencil test administration lacks the global distribution and accessibility potential associated with online tests. Hence, online testing has become a very important component of modern testing.

In some conventional online test environments, a Test Maker stores on a database a pre-packaged test of static questions. In other conventional online test environments, a Test Maker creates a list of static questions indexed to one or more topics such that tests may be formed on the basis of criteria provided by the Test Taker (or another person), where the criteria correspond to one or more indices.

FIG. 4, also background art, shows an exemplary flowchart of conventional online test taking implemented, for example, using a system such as that described in FIG. 2. First, the Test Taker selects an exam S41 using an interface provided by a web server. Next, tests formed from static questions are received S43 from the static questions database 28 through the Test Presenter 21. The user then submits answers S45, and these answers are compared S47 to the correct answers also stored the static questions database 28. From this comparison, the test is scored S48, and then results are sent to the user S49.

Common to all of the above-described background art, the questions prepared by the Test Maker and presented to the Test Taker are all static in the sense that they are composed in their entirety and stored in advance of the administration of the test by a Test Maker. Thus, should a Test Taker re-take an examination, in many conventional systems, the Test Taker would be presented with an exact duplicate of a previously administered test. While using an exact duplicate may enable a Test Taker to compare progress on identical questions, testing with exact duplicates tends to produce results biased by and emphasizing memorization rather than pure skill development.

In more advanced conventional online testing environments, a Test-Taker taking an examination may be presented with a randomized subset of static questions. In some of these advanced conventional systems, records can be maintained to control how many duplicate static questions are re-presented in subsequent test events. Thus, even a large database of questions that can be divided into sub-sets is prone to repeat. Furthermore, the larger the database of static questions developed to provide question randomization and/or enhanced skills testing, the greater the burden on the Test Maker to create, vary, and store the questions.

In addition to the problems associated with static questions, assessment results are often of limited use to a Test Taker as the Test Taker is often ill equipped to identify relevant solutions for remedying identified deficiencies in knowledge or performance. Moreover, a Test Taker often does not have the time to explore solutions and/or available methodologies (i.e., live instruction, printed material, multimedia, etc.) which would be most effective relative to the test subjects assessment and availability.

Therefore, what is desired, as discovered by the present inventors, is a method, system, and computer program product for creating and administering dynamic questions and tests. What is also desired, as discovered by the present inventors, is a method, system, and computer program product for interactively providing solutions and recommendations related to assessed performance to a Test Taker, a Test Maker, a Test Administrator/teacher, a supervisor or human resources agent, or a vendor based on a dynamic test result or assessment.

### SUMMARY OF THE INVENTION

An exemplary embodiment of the present invention includes a method, system, and computer program product for creating and administering dynamic questions and assessments. In another embodiment, there is a method, system, and computer program product for providing recommendations related to assessed performance to a Test Taker, a Test Maker, a Test Administrator/teacher, a supervisor or human resources agent, or a vendor based on the results of a dynamic test. An additional embodiment involves dynamic questions that are related to a body of knowledge arranged hierarchically. The system may include a computer implemented target assessment system configured to interactively present a plurality of assessment driven solutions to a Test Taker in response to a dynamically created assessment. An interface provides a set of dynamically constructed questions to a Test Taker. In turn, the Test Taker provides responses to the set of questions. At least one database stores dynamic solutions to the set of dynamic questions and a plurality of assessment driven solutions. Assessment driven solutions are linked to subject areas assessed by a knowledge assessment calculator (KAC). A processor of the system has an instruction set for comparing the responses of the Test Taker to the dynamic solutions of the database for determining an assessment of the Test Taker. The assessed level of knowledge is used to identify at least one of a plurality of assessment driven solutions for interactive presentation to at least the Test Taker via the interface.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings. The components in the drawings are not necessarily to scale, emphasis instead being placed upon clearly illustrating the principles of the present invention. Moreover, in the drawings, like reference numerals designate corresponding parts throughout the several views.

FIG. 1 is an example of background art showing a system diagram of an existing online test using static test questions;

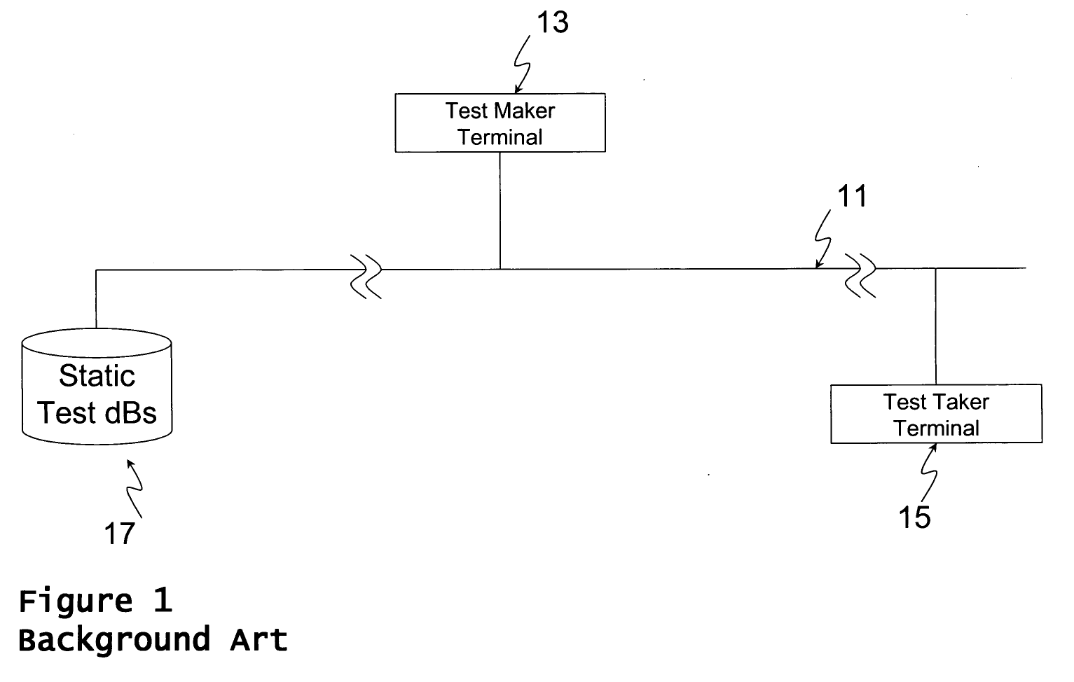

FIG. 2 shows an example of a background art system detail diagram;

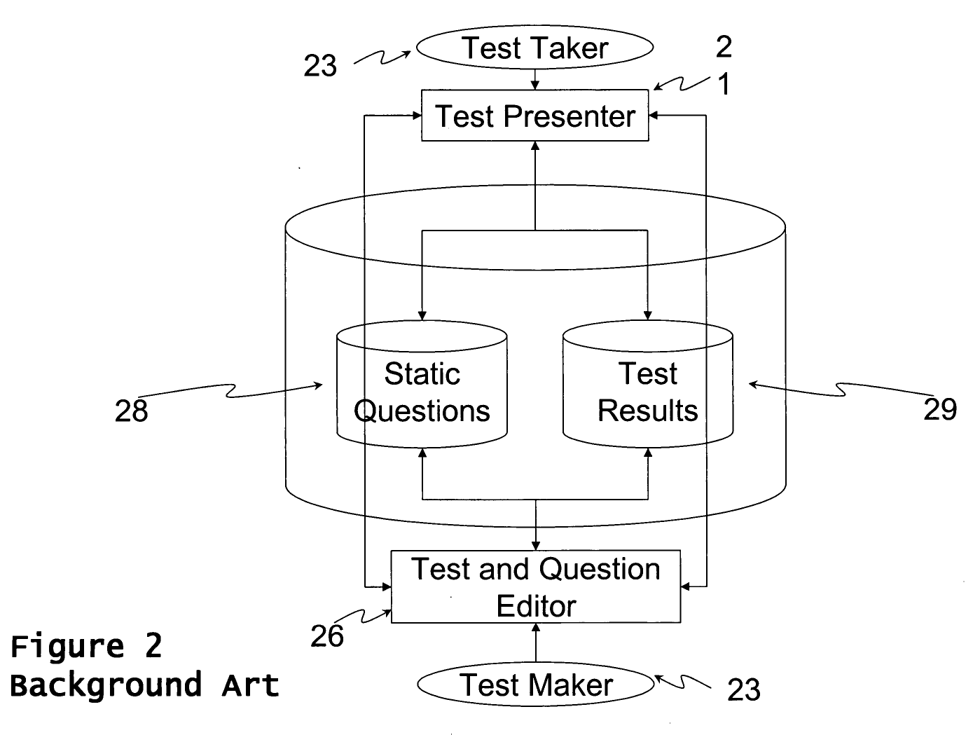

FIG. 3 shows an exemplary flowchart of the administration of a background art paper and pencil test;

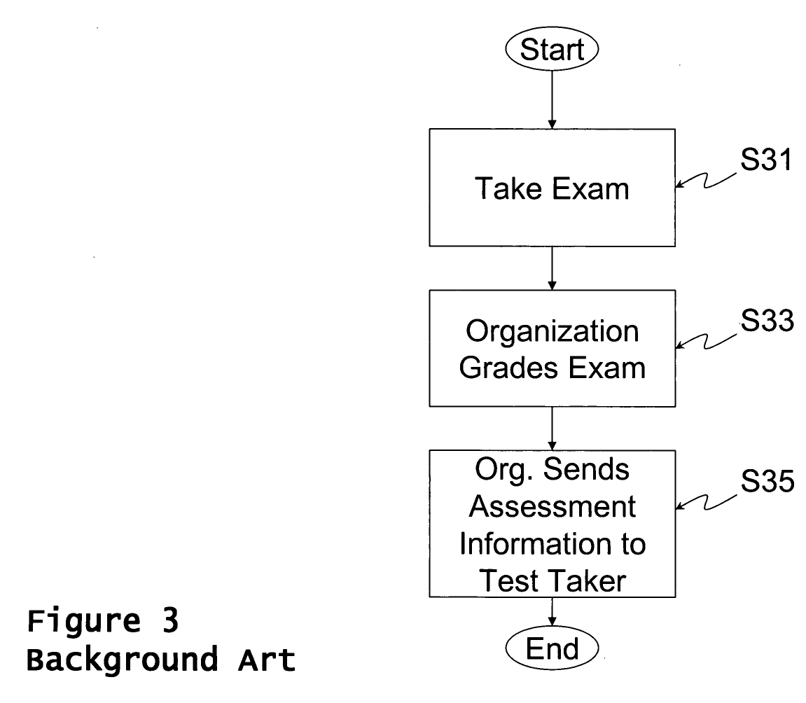

FIG. 4 shows an exemplary flowchart of an online test currently used by industry;

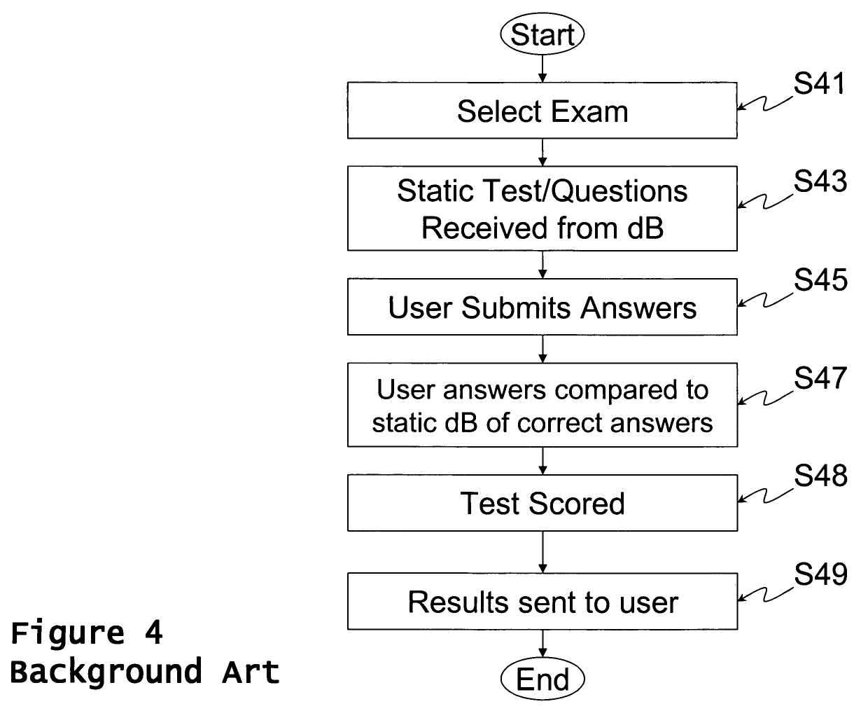

FIG. 5 is an exemplary system diagram of the KAC;

FIG. 6 is an exemplary system detail diagram of the KAC;

FIG. 7 is an exemplary flowchart of a Test Maker's interaction with the Question Manager;

FIG. 8 shows an exemplary flowchart of a Test Maker using the Test Manager;

FIG. 9a describes an exemplary process of a Test Maker managing recommendation scenarios;

FIG. 9b is an exemplary flow chart of a Test Maker's experience managing product recommendation links in the Recommendations Manager 611;

FIG. 9c is an exemplary flowchart of a Test Maker using the Recommendations Manager to manage general recommendation scenarios;

FIG. 10a shows an exemplary flowchart of the process of displaying recommended products to a Test Taker;

FIG. 10b is an exemplary flowchart of the process by which the KAC system recommends products;

FIG. 11 shows an exemplary flowchart of a user's experience with the KAC;

FIG. 12 shows a conceptual diagram illustrating the possible destinations of the results and recommendations of the KAC system; and

FIG. 13 is a block diagram of a computer system upon which an embodiment of the KAC may be implemented.

### DETAILED DESCRIPTION OF THE EMBODIMENTS

Certain terminology used in the following description is for convenience only and is not limiting. The terms “assessment” and “test” are used interchangeably in describing the evaluation of skills or knowledge through a set of questions. Assessment based solutions and recommendations can include, but are not limited to, software, links to services provided on the Internet, study guides, instructional books, and educational videos. The term “Test Maker” describes any entity or group that creates or modifies the test-creating or recommendation-making functionality of the KAC system. Potential Test Makers can include any organization associated with a defined body of knowledge, such as certifying professional organizations. In this case, such organizations can provide KACs for their members for assessment of skills required by the profession for certification or competency. Further, the term “Test Taker” refers to any entity or group that uses the KAC system to assess his or her knowledge level in a particular subject area or areas. Additionally, the KAC system described can be understood to include a plurality of individual KACs that can vary by, for instance, subject area, creator, or sponsoring organization. Moreover, the KAC system can be understood to incorporate and accommodate a plurality of Test Makers and/or Test Takers. For instance, a Test Maker can administer a substantially similar test to multiple Test Takers using a Test Manager to be defined functionally herein.

The present invention provides a computer implemented target assessment system. The target assessment system is configured to interactively present a plurality of assessment driven solutions and recommendations to a Test Taker in response to a knowledge assessment that uses a set of dynamically created questions. The assessment can be utilized to identify a set of assessment driven solutions and recommendations corresponding to an assessed level of knowledge for interactive presentation to a Test Taker via an interface.

In an exemplary embodiment, a Test Taker is assessed using a dynamically constructed test in a particular area, for example, payroll, in accordance with a corresponding request. Once a Test Taker completes the KAC corresponding to payroll, based on the responses to the dynamic test provided by the Test Taker and demonstrated level of knowledge as determined by the KAC, the system can recommend at least one of a training plan and solution for the Test Taker. The training plan may focus on a single segment of a target user's knowledge base or the entire skill set, include pro-active routing or direction to a web-based storefront to register for or purchase online courses, seminars, conferences, publications, audio seminars, instructor-led classes, and any combination of the aforementioned.

In an exemplary embodiment, the Test Taker accesses the KAC through a computer implemented web interface such as from a personal computer (PC) operably linked to a network for accessing documents via the IP protocol suite. The KAC is accessed through HTTP protocol as a web page.

Of course those skilled in the art will recognize that a plurality of KACs may be accessed through the web page and that the specific KAC subjects described herein are exemplary only. For example, multiple KACs may be linked via a common web page so that client organizations of the system can provide direct links into their respective web pages hyperlinked to their KACs. A link may be offered to go directly into a client organization web page, if an individual is interested in solutions of such client organizations such as professional and vocational organizations.

In this way, KACs as described herein are provided relative to referenced products and services of client organizations. For example, KACs may be used for individual career/knowledge assessment, corporate career development, corporate/departmental development, performance appraisal, skill set review for hiring, and career counseling. A KAC might also be used, for example, for test preparation, self-assessment by Test Takers, or certification by a professional association. Moreover, the presentation of relevant products or training-based solutions presents a source of non-dues revenue to certifying associations. The foregoing list is exemplary rather than exhaustive and those skilled in the art will recognize alternative applications.

Referring now to the drawings, wherein like reference numerals designate identical or corresponding parts throughout the several views.

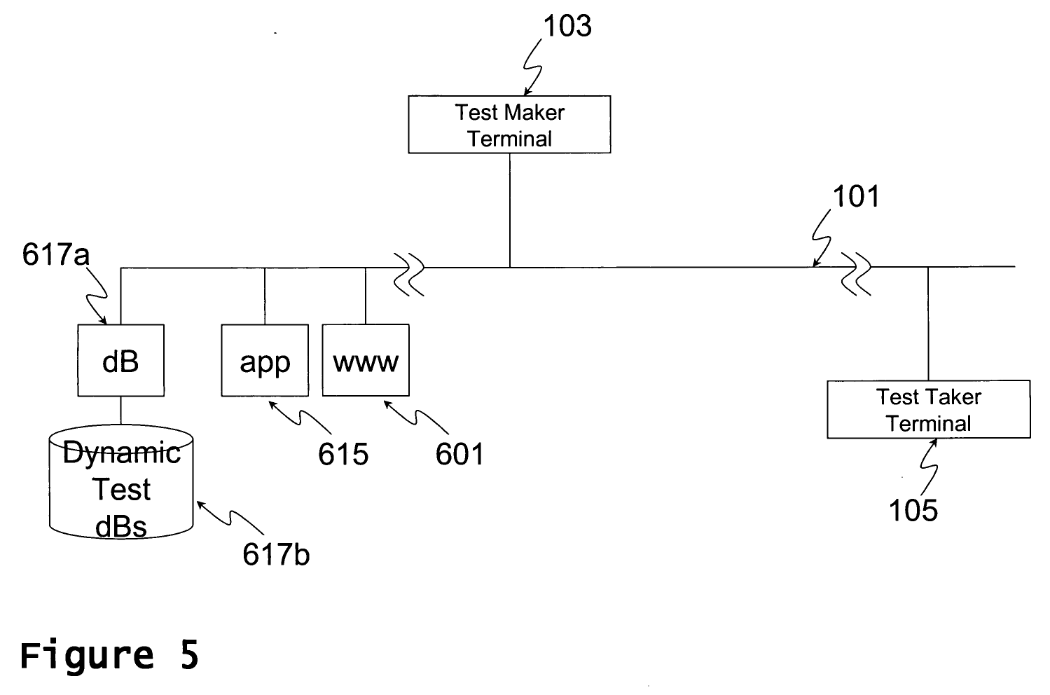

FIG. 5 is an exemplary system diagram describing the high level functionality of network components and in accordance with an embodiment of the present invention. At least one Test Taker and at least one Test Maker interact with the KAC over an internet or intranet network system 101. Their interaction is accomplished through at least one Test Maker terminal 103 and at least one Test Taker terminal 105. The terminals 103, 105 may be remote Personal Computers (PCs) employing a suitable browser application such as MICROSOFT IE® or NETSCAPE NAVIGATOR®. The remote devices are configured to access a public network, such as the Internet for connecting to the web server 601. The discussion of routine HTTP protocol handshaking and DNS query processing is omitted here for sake of brevity. In alternative embodiments, the KAC may be provided by a stand-alone computer, or accessed through a remote device such as a handheld PDA or the like through any number of wireless protocols such as such as BLUETOOTH® and I.E.E.E. 802.11× wireless Ethernet.

In an exemplary embodiment, the network 101 includes “server components” such as a web server 601, an application server 615, a database server 617a, and at least one dynamic test database 617b. In an exemplary embodiment a web front end is provided to present a graphical user interface (GUI). The server components employ a windows based operating system, however alternative operating systems may include but are not limited to Unix, Solaris, Linux, as well as APPLE MAC-OS. Thus, the web server 601 provides the front end for connection to the network such as the Internet. In an exemplary embodiment, the web server 601 employs MICROSOFT® WINDOWS 2000 Server IIS, Active Directory, and FTP. Likewise, the application server 615 employs MICROSOFT® Windows 2000, COM and DOT net services and the database server employs MICROSOFT® WINDOWS 2000 Server and MS SQL for interfacing Dynamic Test databases 617b. The interface provided by the web server 601 may display a plurality of KACs.

The Test Maker and Test Taker each interact with the KAC system through respective terminals, which may include a web server 601, an application server 615, and a database server 617a. The database server 617a has functional access to at least one dynamic test database 617b. In the case of the Test Taker, the dynamic tests are served using the database, application, and web servers. From the Test Maker's perspective, the Test Maker can, using the Test Maker terminal 103, manage the KAC data and functionality through the system servers 601, 615, 617a.

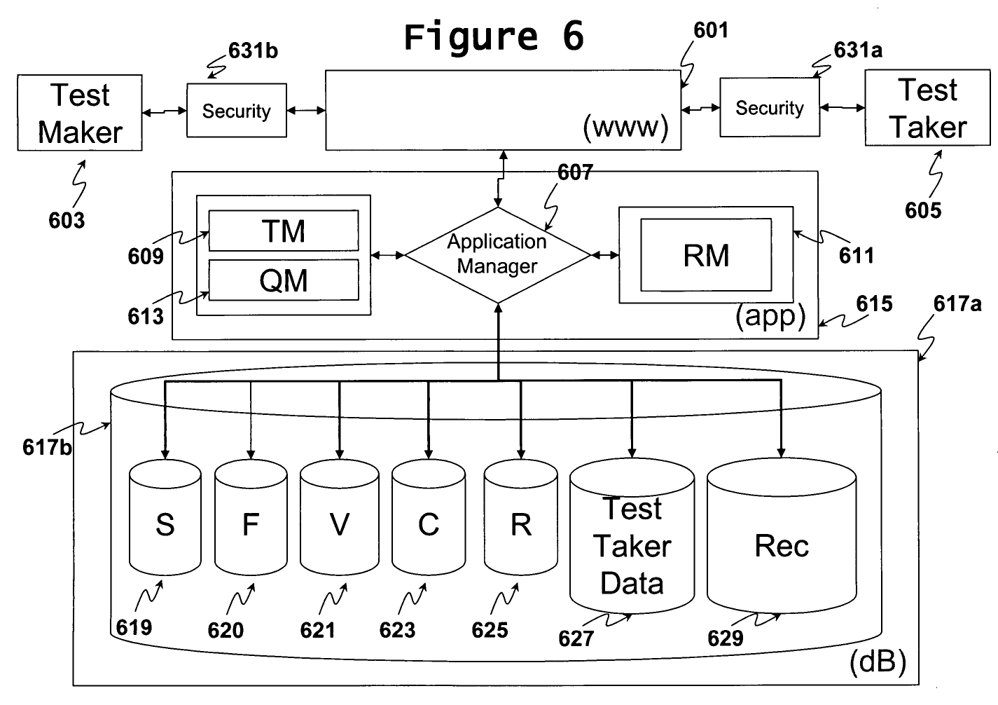

FIG. 6 is, an exemplary system detail diagram for one embodiment of the KAC. A web server is shown at 601, a Test Maker at 603, and a Test Taker at 605. Consistent with FIG. 5, the application server is shown at 615 and the database server is at 617a. While not shown explicitly, a Test Maker can be understood to be interacting with the system via a Test Maker terminal 103 (shown in FIG. 5), and a Test Taker can also be understood to be interacting with this system through a Test Taker terminal 105 (shown in FIG. 5). On the application server 615 are provided at least a Test Manager (TM) 609, a Question Manager (QM) 613, a Recommendations Manager (RM) 611 and-an Application Manager 607. Optionally, security measures 631a and/or 631b are provided, such as firewalls, biometrics, and encryption, to increase the security of transactions and requests sent over network links outside and inside the KAC system.

The Test Manager 609, Question Manager 613, Recommendations Manager 611 and Application Manager 607 are meant to be notional representations of functional groups within the KAC software. The Test Manager 609 handles the management of tests created and designed by a Test Maker as well as creating and sending an appropriate dynamically constructed test to a Test Taker when requested. The Question Manager 613 is responsible for the management of all question components used to dynamically construct questions according to rules and parameters defined by a Test Maker.

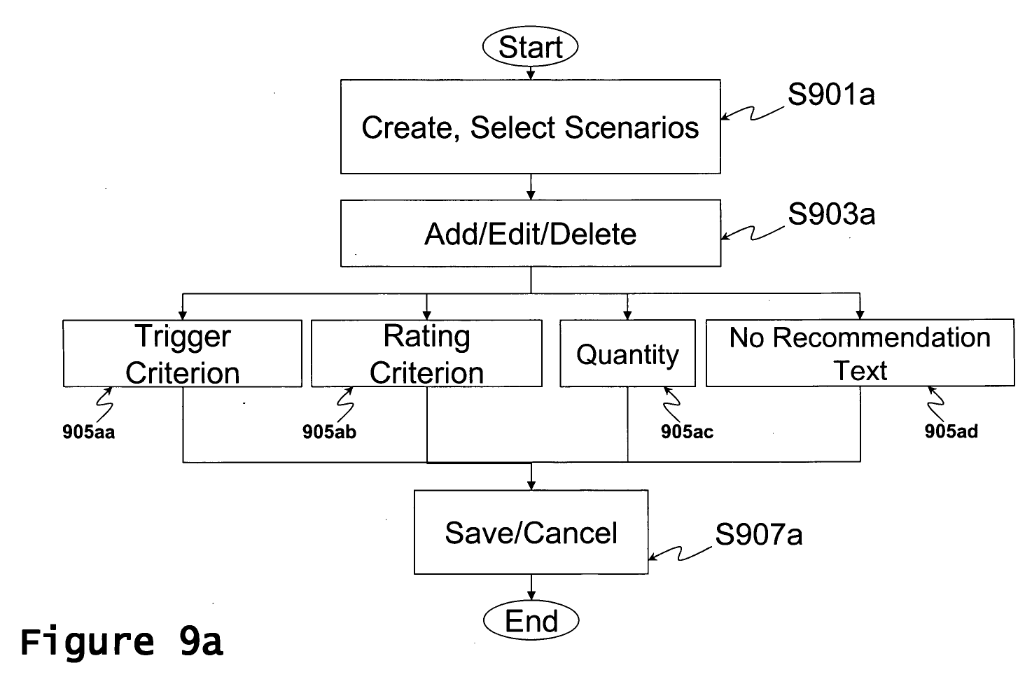

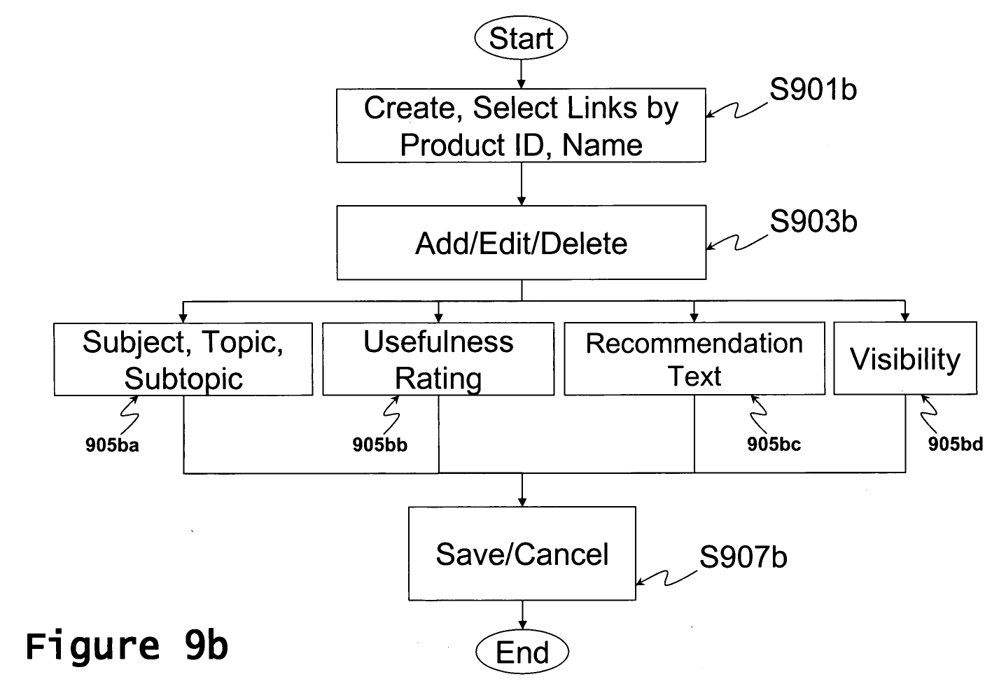

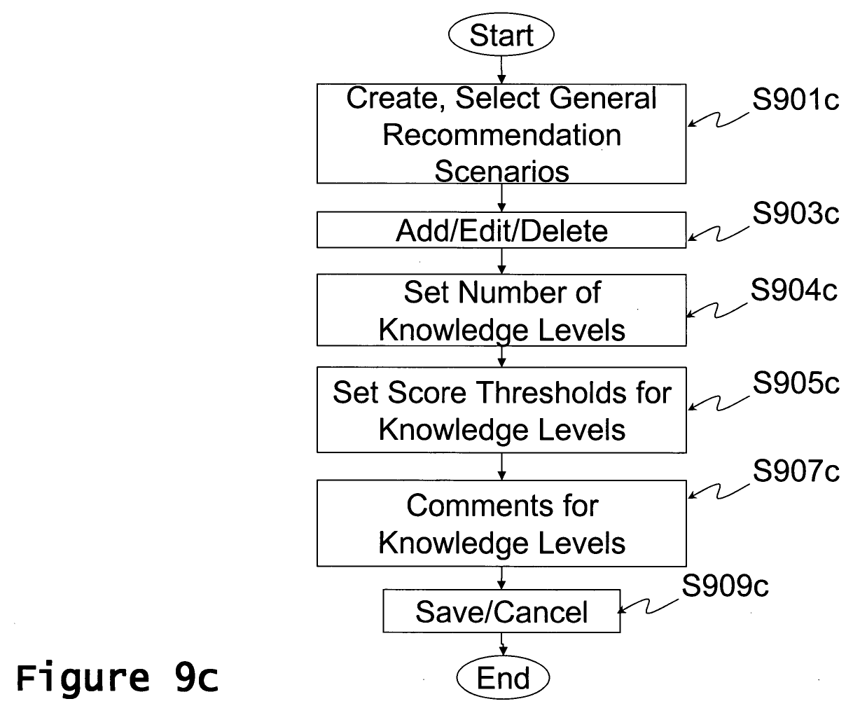

The Recommendations Manager 611 has at least three sub-functions. For example, the Recommendations Manager 611 may handle the management of recommendation scenarios (Described further relative to FIG. 9a). The Recommendations Manager 611 may also manage the links between recommendable products and the conditions under which they will be recommended by the KAC (Described further relative to FIG. 9b). Additionally, the Recommendations Manger 611 may manage general recommendation scenarios to provide a Test Taker, for example, with general, non-product-linked recommendations based on the Test Taker's demonstrated performance (Described further relative to FIG. 9c).

The Application Manager 607 provides interconnects with the various components of KAC software, including the Test, Question, and Recommendations Managers 609, 613, 611. The Application Manager performs functions such as routing requests from the above Managers to retrieve data from the databases handled by the database server 617a. Another example of an Application Manager function includes the comparison of Test Taker responses to correct solution formulas defined using the Question Manager 613 and stored a database within the KAC databases 617a.

The KAC system may also include a Report Manager (not shown) and an Administrative Tools Manager (not shown). A Report Manager can be configured to organize various final and intermediate data outputs within the KAC system for reporting via email screen display, printing, etc. An Administrative Tools Manager can coordinate permissions information such as data access, user profiles, etc.

The database server 617a is functionally linked to a dynamic test database 617b. This, in turn, contains at least a stem text (S) database 619, a formulas (F) database 620, a variables (V) database 621, a constants (C) database 623, a ranges (R) database 625, a Test Taker data database 627, and a recommendations (Rec) database 629. Although the features within 617b are depicted as databases, they can be understood to include any searchable, indexed data structure including databases and tables. Moreover, the features with 617b can be implemented in any number of such data structures.

In the case of a Test Taker 605, the Test Taker interacts with the system via an interface (e.g. GUI) provided by a web server 601. This web server 601 sends requests and data to and from the Test Taker to the application server 615. The Application Manager 607 directs and requests data appropriately to one of the Test Manager 609, Question Manager 613, or the Recommendations Manager 611.

For example, if a Test Taker selects a test topic and level of difficulty for a KAC, the Application Manager 607 routes the request appropriately to the Test Manager 609, which in turn, constructs an appropriately constructed dynamic knowledge assessment (test) based on dynamic question components from databases at 619, 620, 621, 623, and 625. This dynamically created test is then sent to the web server 601, where the Test Taker can view the test and respond to the dynamically created questions. The responses to these questions can be stored in the Test Taker data database 627, via the Application Manager 607.

It is also possible for a group of individuals to request or be provided with a common and/or related assessment. In the group setting, the group ID may either be input by the Test Taker or be provided to the Test Taker by the system. As with an individual test taker, the Application Manager 607 directs and requests data appropriately to one of the Test Manager 609, Question Manager 613, or the Recommendations Manager 611. Depending on an option selected by either the test takers or a test administrator/requestor, the plural test takers may be provided with one or more identical questions; one or more questions with identical stems but with different ranges, constants, and variables; or one or more completely different questions related to the identified assessment.

Upon completion of the test, the Application Manager 607 may compare the responses to the questions stored in the Test Taker data database 627 to the known solutions or formulas defined by the Test Manager 609 and Question Manager 613. The above comparison results in a score (or set of scores if the test covers more than one subject/topic/subtopic or KAC) which is also stored in the Test Taker data database 627. The Test Taker data database 627 can also store demographic information such as Test Taker names, addresses, billing information, and industry affiliation. Then the Test Taker's score for each subject/topic/subtopic or KAC is compared to a database of recommendations 629 using logical rules in the Recommendations Manager 611 and the Application Manager 607. Subsequently, the appropriate recommendations are sent to the Test Taker by the Application Manager via the web server 601.

With regard to the Test Maker 603, the Test Maker interacts via the web server 601 with the managers 609, 611, 613 in the application server 615. For instance, the Test Maker can use the Question Manager 613 to add, edit or delete any of the dynamic questions or components therein stored in stem, formula, variable, constant, or recommendation databases (i.e., S, F, V, C, or R, corresponding to 619, 620, 621, 623, and 625, respectively). The Test Maker can also use the Test Manager 609 to construct rules for the creation of dynamic tests for evaluation of Test Takers 605. The Test Maker can also, using the Recommendations Manager 611, edit the recommendation products stored in the recommendations database 629 and the rules controlling the recommendation of products in the Recommendations Manager 611. With regard to editing, the Recommendations Manager 611 allows for direct editing of recommendations and recommendation rules as well as activating and deactivating recommendations. Furthermore, the Recommendations Manager 611 allows for annotating recommendations and recommendation rules with non-publishable and non-publishable Test Maker comments and instructions.

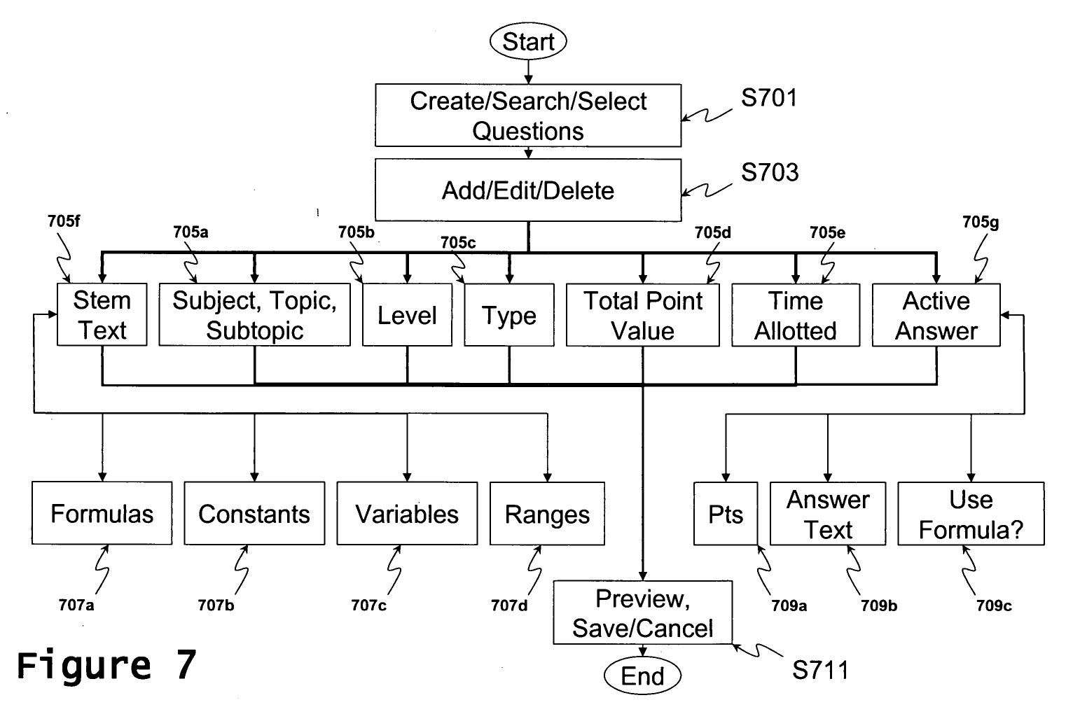

FIG. 7 is an exemplary flowchart of a Test Maker's interaction with the Question Manager. First, the Test Maker can create, browse, search or select questions at 701. Then, the Test Maker can choose to add, edit or delete the selected question at 703. Next, the Test Maker can choose to add, edit or delete any of the components of each question, including the subject, topic, or subtopic of the question 705a, a difficulty level of the question 705b, the question type 705c, a total point value 705d for a fully correct answer, the time allotted for the particular question 705e, as well as the stem text 705f of the question and the active answer 705g.

The difficulty level of a question can be determined in one of several ways. The difficulty might be, for example, defined by the Test Maker explicitly. Another non-limiting example allows the difficulty to be determined empirically by an analysis performed by the Application Manager 607 of past performance by Test Takers stored in the Test Taker data 627 on questions of a similar parameter (e.g. length 705e, type 705c, or functional form 707a).

In the case of the stem text 705f, the Test Maker can define formulas 707a, constants 707b, variables 707c, and ranges 707d, to allow for dynamically created questions. Stem text represents a general framework for dynamic questions, and can contain a combination of words, formulas, variables, constants, and ranges as well as a question stem defining the problem to be solved by the Test Taker. An example of stem text could be “A transferred employee drives [A] miles and submits a bill to his employer for $[variable01] for a hotel room, $[B] in meals (including tips), and $[variable 02] for mileage. What portion of the costs is taxable?” In this example, [A], [B], [variable01], and [variable02] can represent variables selected randomly from a particular range of values or defined using a formula to be a function of another set of variables or constants. These formulas, constants, variables, and ranges can be stored in their respective databases (at 620, 621, 623, and 625). As a related function, the Question Manager 613 can also be understood to implement formula checking for errors, circular references, and omitted values.

With regard to editing, the Question Manager 613 allows for direct editing of questions, solutions, and question rules as well as activating and deactivating questions and/or solutions. Furthermore, the Question Manager 613 allows for annotating questions, solutions, and question rules with publishable and non-publishable Test Maker conmments and instructions.

The Dynamic Test databases 617b may also include a static question database (not shown) containing predetermined questions not composed of any of stem text, constants, variables, or ranges, and can be integrated to work with the database server 617a and Dynamic Test databases without impacting the functionality of the KAC described herein.

In a non-limiting example, formulas may be algebraic in form or make use of formal logic to allow for text-based dynamic questions. Also, variables 707c can include numbers (or, possibly, text strings if the formula is in logical form). Also, ranges 707d can be defined by a set of numbers or a set of text options from which a selection or match is made.

In defining an active answer 705g, the Test Maker assigns points 709a to be awarded for a correct answer and any associated rules for giving a part of the total points possible for alternate or “close” answers. The Test Maker also may define the answer text 709b provided to a Test Taker, and denote whether or not the question uses a formula 709c to allow for the consistent evaluation of dynamically created questions. If the question uses a formula, then the active answer 709g will incorporate the appropriate question components (such as formulas 707a, constants 707b, variables 707c, and ranges 707d) to accurately evaluate responses to the question. Depending on the question type, wrong answers may be provided (e.g. the case of multiple choice-type or True/False questions). Also, for instance, active answers based on formulas may have a degree of tolerance defined by the Test Maker to allow for approximate responses by the Test Taker to be scored as fully or partially correct answers. Having altered, created, or deleted any of the components of the question or entire questions, the user can save or cancel changes S711.

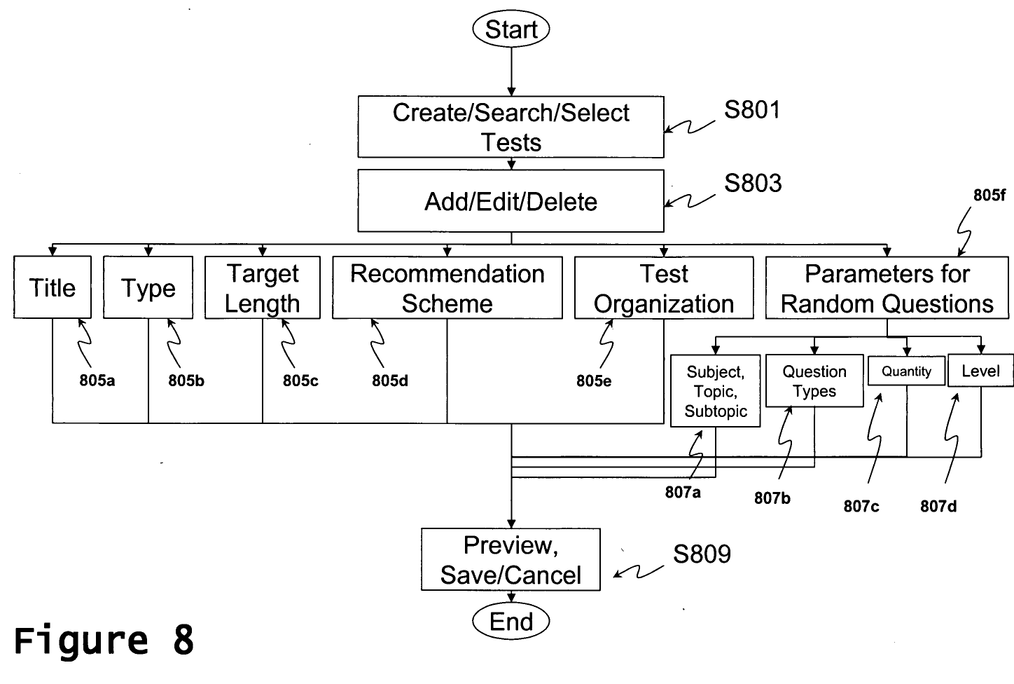

FIG. 8 shows an exemplary flowchart of a Test Maker using the Test Manager. Having selected to work with the Test Manager, the Test Maker creates, browses, searches or selects tests S801. After selecting a test, the Test Maker can add, edit or delete a test or part of a test S803. The various configurable parameters of a test include a title 805a, type 805b, target length 805c, recommendation scheme 805d, test organization scheme 805e, and parameters for random questions 805f.

Test Target length is used by the Test Manager 609 to select a set of dynamic questions that have a sum Time Allotted 705e approximate to the target length. The organization scheme can be understood to be a set of at least one rule defining the order of question types, subject areas, difficulty, etc

Optionally, the Test Manager 609 can stipulate that questions be selected for a test in a random fashion. Defining parameters for random questions 805f allows the Test Manager 609 to create dynamic tests by choosing a particular and customizable set of dynamic questions from the question component databases, wherein the choice is made by specifying random question parameters 805f. Parameters for random questions 805f can include the subject, topic, and subtopic 807a, question types 807b (e.g. multiple choice, fill-in-the-blank, etc.), the quantity of questions 807c, and the level of difficulty of random questions selected 807d by the Test Manager 609. By allowing for customizable and dynamic selection of parameters (or ranges of parameters) for random questions 805f, the Test Manager 609 can create targeted tests containing a wide variety of dynamic question types, subject areas, and difficulties that are unique for each individual Test Taker and unique for each instance of assessment. Having added, edited or deleted the desired tests or components of tests, the Test Maker can then preview a test or save or cancel changes S809.

With regards to editing, the Test Manager 609 allows for direct editing of tests and test rules as well as activating and deactivating tests. Furthermore, the Test Manager 609 allows for annotating tests and test rules with publishable and non-publishable Test Maker comments and instructions.

FIGS. 9a, 9b, and 9c are exemplary flow charts describing a Test Maker's experience using the Recommendations Manager to manage recommendation scenarios, product recommendation links, and general recommendation scenarios. These functions can all be understood to be included within the scope of the Recommendations Manager 611.

FIG. 9a describes an exemplary process of a Test Maker managing recommendation scenarios. A recommendation scenario is a set of rules that describes when and how the KAC makes recommendations from assessment results. First, the Test Maker can create a new scenario or browse/search and select existing scenarios to manage S901a. Having selected a scenario, the Test Maker can then choose to add, edit, or delete the selected scenario S903a. The various editable components of scenarios can include the Trigger Criterion 905aa, Rating Criterion 905ab, maximum recommendation quantity 905ac, and the text in the case of no recommendation 905ad.

The Trigger Criterion 905aa describes a recommendation parameter condition that must be met in order for a certain recommendation scenario to be activated. For example, a Trigger Criterion can include a case when a Test Taker's score in a certain subject area is less than 60%.

Next, the Rating Criterion 905ab describes a set of conditions that influences what kinds of products are recommended in case a certain scenario is activated. As an example of a rating criterion, if a Trigger Criterion 905aa is met, the KAC system might then recommend only products that have been rated as “Very Helpful” with regards to a certain subject area.

Quantity 905ac describes the number of recommendations and recommended products returned by the system in case a scenario is activated. In case no recommendations are made after a Trigger Criterion is met, text defined in a No Recommendation Text 905ad field can be returned to the Test Taker. Having added a new scenario or edited an existing scenario, the Test Maker can choose to save or cancel changes or additions S907a.

FIG. 9b is an exemplary flow chart of a Test Maker's experience managing product recommendation links in the Recommendations Manager 611. First, the Test Maker can create new links or browse/search and select existing links by product identification or product name S901b. Having selected a specific product's links, the Test Maker can add, edit, or delete these links S903b. Each product in the recommendations database 629 includes a subject, topic, and subtopic to which-that product is related 905ba. Also included is a rating of the product's relevance 905bb to at least one subject or topical area. In addition, a text message 905bc can accompany a recommended product. Yet another component of a product link is its visibility 905bd. The visibility characteristic defines whether or not a particular product, while relevant in terms of subject, topic, or subtopic, is able to be recommended by the system. Having added, edited or deleted product recommendation links for a given product, the Test Maker can save or cancel his or her changes S907b.

FIG. 9c is an exemplary flowchart of a Test Maker using the Recommendations Manager 611 to manage general recommendation scenarios. General recommendation scenarios are messages created by the system and relayed to the Test Taker providing general feedback on the Test Taker's performance not specifically linked to products linked in the recommended products database 629. The Test Maker begins by creating a new scenario or browsing/searching and selecting existing general recommendation scenarios S901c. Having selected a general recommendation scenario, the Test Maker can add, edit, or delete a scenario S903c. The Test Maker then sets the number of knowledge levels S904c for the general recommendation scenario selected. The knowledge levels S904c can be used to characterize a Test Taker's performance in terms of degrees of competency in an area, for example “poor,” “average,” or “superior.” Next, the Test Maker sets minimum score thresholds for the knowledge levels S905c. For example, a score threshold to be characterized as “superior” from the example above might be 95, or answering 95% of the questions in a certain subject area correctly. The Test Maker can also use the Recommendation Manager's general recommendation scenario feature to compose comments for particular knowledge levels S907c. These comments can include a more detailed description of how the Test Taker's score reflects his or her knowledge level in an area or an outlined review plan to guide a Test Taker in self-study. Having defined any subset of these characteristics of general recommendation scenarios, the Test Maker can save or cancel these changes S909c.

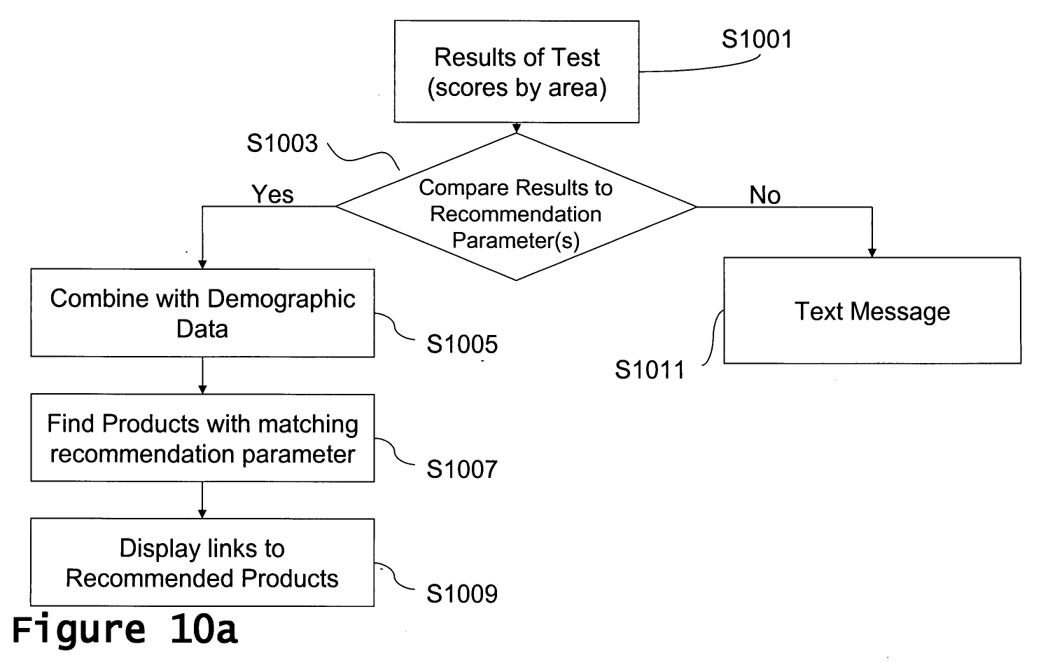

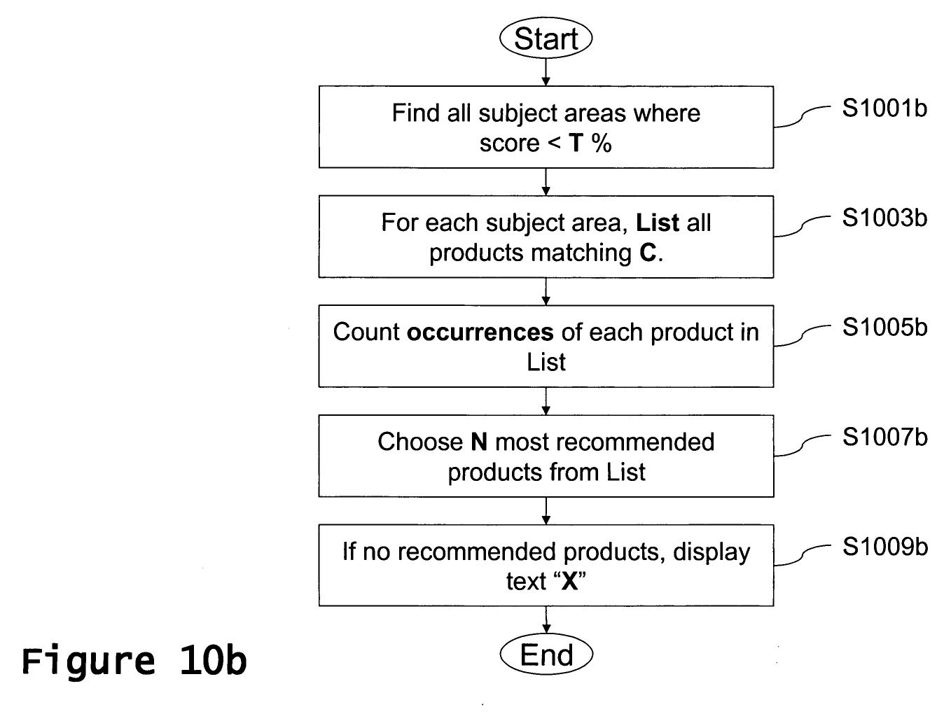

FIG. 10a shows an exemplary flowchart of the process of displaying recommended products to a Test Taker. The process begins by having the results of a test and the performance in particular areas within the test S1001. The results are then compared to recommendation parameters S1003, where recommendation parameters can include the subject, topic, and subtopics of areas with which products in the recommendation database 629 are associated. If the comparison of results to recommendation parameters yields no recommendations (for example, if a Test Taker scores perfectly in all areas and recommendation rules are defined so recommendations are only made in areas where a Test Taker has missed a number of questions), then a text message is displayed S1011 to the user, for example, describing that no recommended products or services are currently available for the relevant subject area. If the step of comparing results to recommendation parameters S1003 does yield recommended products, then the relevant results can be combined with Test Taker demographic data S1005 to find products with matching recommendation parameters S1007. Ultimately, links can be displayed to the Test Taker for recommended products S1009 associated with the results of the Test Takers test. The KAC may also provide default recommendations for display to a Test Taker regardless of the results of an assessment.

FIG. 10b is an exemplary flowchart of a process by which the KAC system recommends products. After the Test Taker has completed the assessment, the system scores the results and finds all subject areas where a score is less than a certain threshold S1001b, wherein these thresholds can be, for example, defined in the recommendations scenarios feature under Trigger Criterion 905aa. Next, for each subject area, the system lists all products matching a certain criterion “C”, where “C” could be a minimum level of product usefulness in a certain subject area 905bb, and where this list may or may not be shown to the Test Taker S1003b. Next, the system counts the occurrences of each product made in the previous step S1005b. The system then chooses the “N” most recommended products from the list S1001b where “N” is defined in the product recommendation scenarios at 905ac. In the case that no recommended products are found for the specific subject area, the system then can display a text “X” S1009b, where this text can also be defined in the recommendation scenario at 905ad.

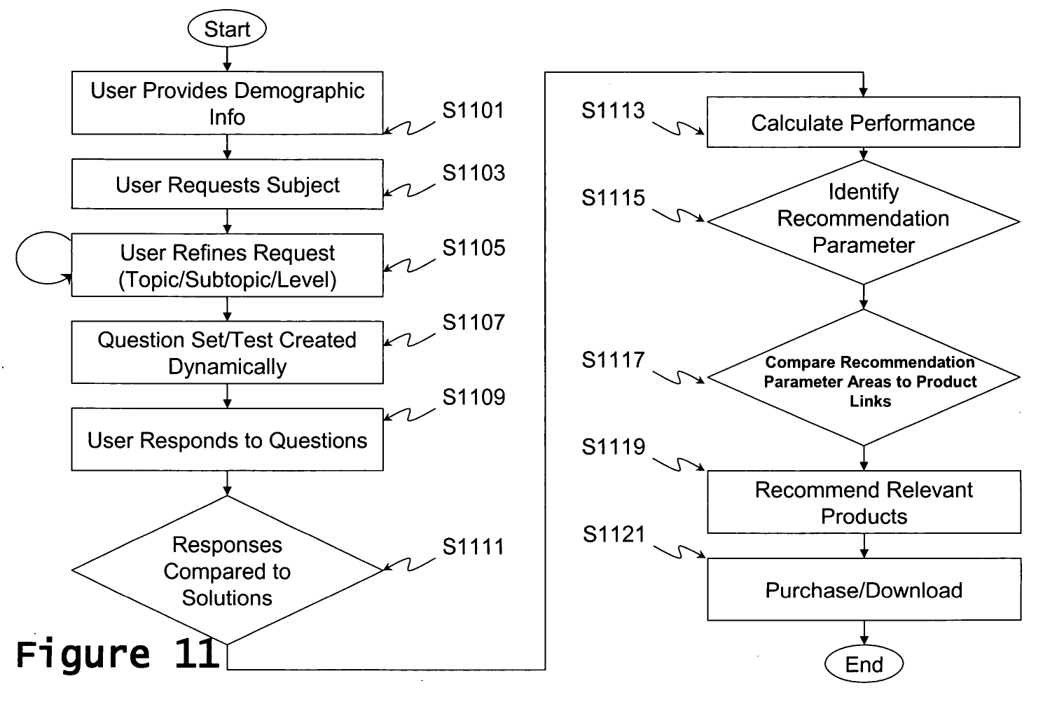

FIG. 11 shows an exemplary flowchart of a new Test Taker's overall experience with the KAC. The process begins with the user providing demographic information S1101, such as name, email address, or selection of login and password information using a Test Taker terminal 105 and an interface provided by the KAC web server 601. Next, having logged in, the user requests a desired subject to be tested or evaluated in S1103. (In the case of a returning Test Taker (where the Test Taker has already provided demographic information), the Test Taker would not be required to repeat step S1101 and could begin at S1103 by logging in using identification information such as a username and password). The user could then refine his or her request in terms of a topic, subtopic, or level of difficulty S1105. From this request, the system returns a question set or test created dynamically according to the user's request S1107. Alternatively, the user could select a specific KAC defined and made available by a Test Maker such as a certifying professional organization (not shown). These requests are handled by the Application Manager 607 and are used by the Test Manager 609 to create a dynamic test relevant to the request. The dynamic test is presented to the Test Taker using the interface provided by the web server 601. The user then responds to the test S1109 containing random and dynamically created questions. Responses are stored in the Test Taker Data database 627. The responses supplied by the Test Taker are then compared to the solutions S1111 by the Application Manager 607. The Test Taker's performance is then calculated S1113 by the Application Manger 607, and recommendation parameters are identified S1115. These recommendation parameters are compared to product links S1117 defined in the Recommendations Manager 611 and the Recommendations database 629, which in turn results in relevant products being recommended to the Test Taker S1119. Presented with these relevant products, the user can choose to purchase, order, or download these products S1121. Having reached this point, the Test Taker can purchase or download products or services by populating and checking out a shopping cart via a local or remote e-commerce engine. The products or services recommended to the Test Taker can include, but are not limited to, items such as articles, books, videos, computer software, links to other websites or online courses, a request for a catalogue to be mailed, or a phone call, and opt-in services such as e-mail newsletters. Alternatively, the Test Taker can either download an order form or otherwise capture information required for research and/or for telephone or mail ordering. Provision of the above-mentioned solutions and recommendations can offer organizations associated with the skills being tested a source of non-dues-based revenue.

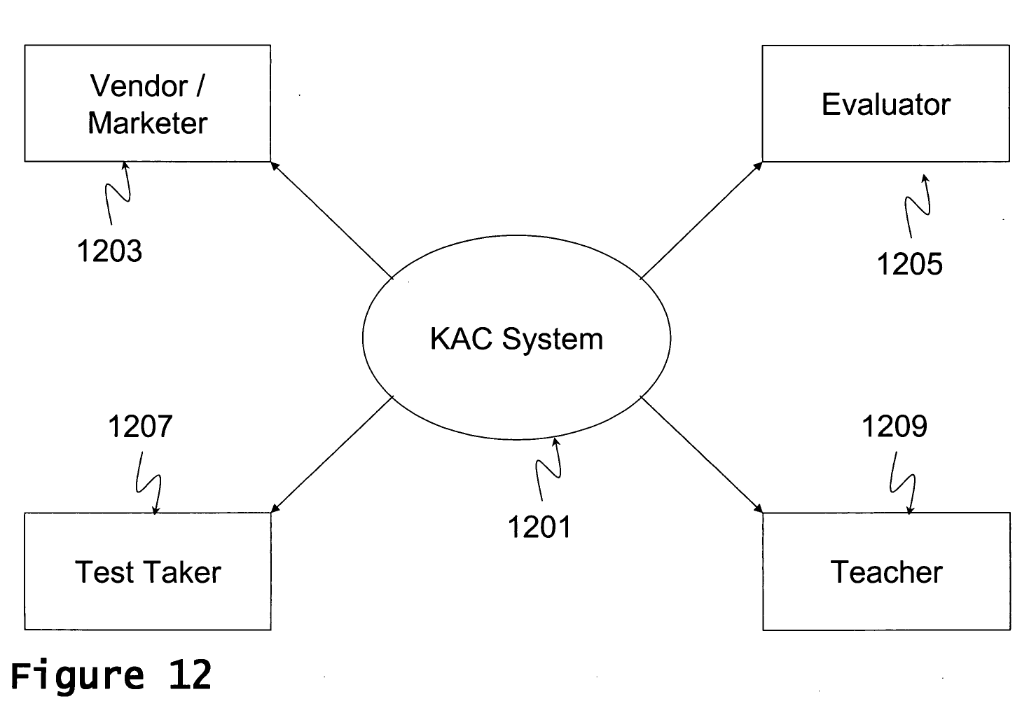

FIG. 12 shows a conceptual diagram illustrating some of the possible destinations of the results and recommendations of the KAC system 1201. According to an embodiment of the KAC system, assessment driven solutions and other KAC outputs (including intermediate outputs such as Test Takers' raw scores) can be made available to other types of users or groups of users besides the Test Taker. For instance, the Test Maker can view the results and statistical records for one or more Test Takers, tests, or questions. Alternatively, KAC outputs can be used by the Applications Manager 607 to analyze particular questions that are of greatest difficulty to Test Takers or other forms of analysis of aggregate performance of Test Takers with respect to KACs.

Other recipients of KAC data outputs can include, for example, vendors and marketers 1203, evaluators such as workplace supervisors 1205, or teachers 1209, in the case that the KAC is used to evaluate performance of students or teachers in an educational environment. The evaluator of the results and recommendations from the KAC system can use this data for performance evaluations, hireability analysis, assessments of a product's suitability to be implemented, promotion decisions, and professional development. In another embodiment, a teacher or proctor can view the results and statistical records for one or more Test Takers, tests, or questions. In addition, the Recommendations Manager 611 can be configured to provide recommendations to the teacher or proctor for improving teaching and/or for products for further recommendation to a student by the teacher. In another embodiment, a vendor can view the results and statistical records for one or more Test Takers, tests, or questions. The Recommendations Manager can also be configured to provide recommendations to the vendor for improving product utility. The applications of the KAC are numerous and varied, and might include estate planning, retirement planning, patent agency or practitioner training, or day trader training. And finally, the Test Taker 1207, can be a recipient of the results and recommendations of the KAC system.

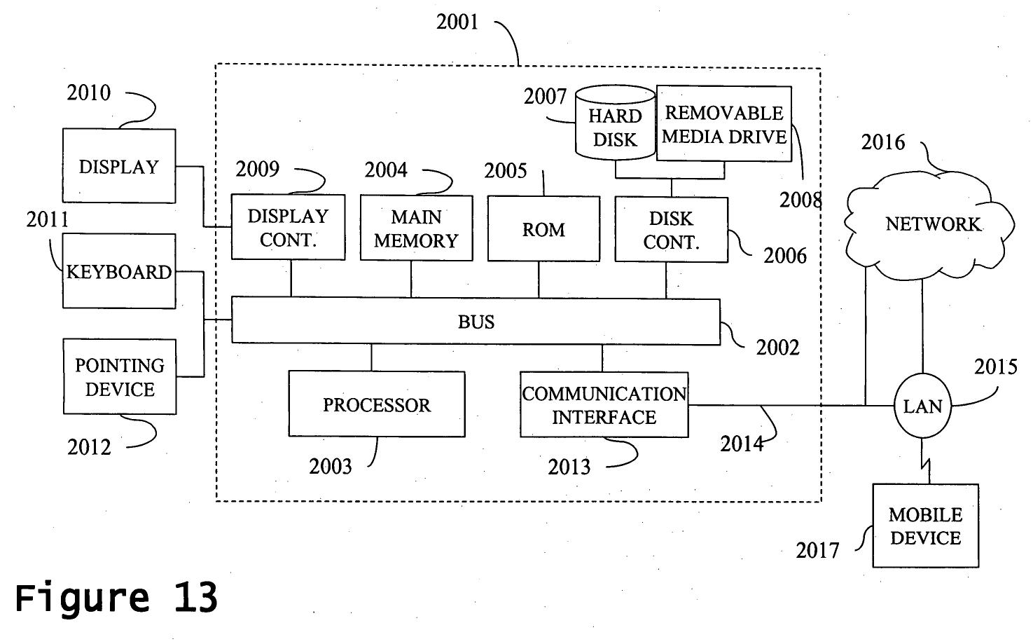

FIG. 13 is a block diagram of a computer system 2001 upon which an embodiment of the present invention may be implemented. It should be noted however, that the present system need not be based on a personal computer (PC) configuration, but rather a custom processor-based system (such as a software and/or hardware modified Tandberg 6000, or Tandberg MCU) that does not include the features of a general purpose computer may be used as well. Nevertheless, because the actual hardware configuration used to support the present invention is not so restricted, an example of PC-based system is now provided. The computer system 2001 includes a bus 2002 or other communication mechanism for communicating information, and a processor 2003 coupled with the bus 2002 for processing the information. The computer system 2001 also includes a main memory 2004, such as a random access memory (RAM) or other dynamic storage device (e.g., dynamic RAM (DRAM), static RAM (SRAM), and synchronous DRAM (SDRAM)), coupled to the bus 2002 for storing information and instructions to be executed by processor 2003. In addition, the main memory 2004 may be used for storing temporary variables or other intermediate information during the execution of instructions by the processor 2003. The computer system 2001 further includes a read only memory (ROM) 2005 or other static storage device (e.g., programmable ROM (PROM), erasable PROM (EPROM), and electrically erasable PROM (EEPROM)) coupled to the bus 2002 for storing static information and instructions for the processor 2003.

The computer system 2001 also includes a disk controller 2006 coupled to the bus 2002 to control one or more storage devices for storing information and instructions, such as a magnetic hard disk 2007, and a removable media drive 2008 (e.g., floppy disk drive, read-only compact disc drive, read/write compact disc drive, compact disc jukebox, tape drive, and removable magneto-optical drive). The storage devices may be added to the computer system 2001 using an appropriate device interface (e.g., small computer system interface (SCSI), integrated device electronics (IDE), enhanced-IDE (E-IDE), direct memory access (DMA), or ultra-DMA).

The computer system 2001 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 2001 may also include a display controller 2009 coupled to the bus 2002 to control a display 2010, such as a cathode ray tube (CRT), for displaying information to a computer user. The computer system includes input devices, such as a keyboard 2011 and a pointing device 2012, for interacting with a computer user and providing information to the processor 2003. The pointing device 2012, for example, may be a mouse, a trackball, or a pointing stick for communicating direction information and command selections to the processor 2003 and for controlling cursor movement on the display 2010. In addition, a printer may provide printed listings of data stored and/or generated by the computer system 2001.

The computer system 2001 performs a portion or all of the processing steps of the invention in response to the processor 2003 executing one or more sequences of one or more instructions contained in a memory, such as the main memory 2004. Such instructions may be read into the main memory 2004 from another computer readable medium, such as a hard disk 2007 or a removable media drive 2008. One or more processors in a multi-processing arrangement may also be employed to execute the sequences of instructions contained in main memory 2004. In alternative embodiments, hard-wired circuitry may be used in place of or in combination with software instructions. Thus, embodiments are not limited to any specific combination of hardware circuitry and software.

As stated above, the computer system 2001 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer-can read.

Stored on any one or on a combination of computer readable media, the present invention includes software for controlling the computer system 2001, for driving a device or devices for implementing the invention, and for enabling the computer system 2001 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 2003 for execution. A computer readable medium may take many forms, including but not limited to, non-volatile media, volatile media, and transmission media. Non-volatile media include, for example, optical, magnetic disks, and magneto-optical disks, such as the hard disk 2007 or the removable media drive 2008. Volatile media include dynamic memory, such as the main memory 2004. Transmission media include coaxial cables, copper wire and fiber optics, including the wires that make up the bus 2002. Transmission media may also take the form of acoustic or light waves, such as those generated during radio wave and infrared data communications.

Various forms of computer readable media may be involved in carrying out one or more sequences of one or more instructions to processor 2003 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 2001 may receive the data on the telephone line and use an infrared transmitter to convert the data to an infrared signal. An infrared detector coupled to the bus 2002 can receive the data carried in the infrared signal and place the data on the bus 2002. The bus 2002 carries the data to the main memory 2004, from which the processor 2003 retrieves and executes the instructions. The instructions received by the main memory 2004 may optionally be stored on storage device 2007 or 2008 either before or after execution by processor 2003.

The computer system 2001 also includes a communication interface 2013 coupled to the bus 2002. The communication interface 2013 provides a two-way data communication coupling to a network link 2014 that is connected to, for example, a local area network (LAN) 2015, or to another communications network 2016 such as the Internet. For example, the communication interface 2013 may be a network interface card to attach to any packet switched LAN. As another example, the communication interface 2013 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 2013 sends and receives electrical, electromagnetic or optical signals that carry digital data streams representing various types of information.

The network link 2014 typically provides data communication through one or more networks to other data devices. For example, the network link 2014 may provide a connection to another computer through a local area network 2015 (e.g., a LAN) or through equipment operated by a service provider, which provides communication services through a communications network 2016. The local network 2014 and the communications network 2016 use, for example, electrical, electromagnetic, or optical signals that carry digital data streams, and the associated physical layer (e.g., CAT 5 cable, coaxial cable, optical fiber, etc). The signals through the various networks and the signals on the network link 2014 and through the communication interface 2013, which carry the digital data to and from the computer system 2001, may be implemented in baseband signals or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 2001 can transmit and receive data, including program code, through the network(s) 2015 and 2016, the network link 2014, and the communication interface 2013. Moreover, the network link 2014 may provide a connection through a LAN 2015 to a mobile device 2017 such as a personal digital assistant (PDA) laptop computer, or cellular telephone.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

Readily discernible modifications and variations of the present invention are possible in light of the above teachings. It is therefore to be understood that within the scope of the appended claims, the invention may be practiced otherwise than as specifically described herein. For example, while described in terms of both software and hardware components interactively cooperating, it is contemplated that the system described herein may be practiced entirely in software. The software may be embodied in a carrier such as a magnetic or optical disk, or a radio frequency or audio frequency carrier wave.

Thus, the foregoing discussion discloses and describes merely exemplary embodiment of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

What is claimed is:

1. A computer-based method of administering an assessment, comprising steps of:
receiving a request for said assessment;
presenting a test corresponding to said requested assessment; and
deriving a dynamic question for inclusion from an electronic archive for inclusion in said test, said dynamic question including a stem question and one of a stem question formula, a stem question range, a stem question variable, and a stem question constant.

2. The method of claim 1, wherein said test also includes a static question.

3. The method of claim 1, wherein said step of receiving a request comprises:
receiving and storing a user identification and an assessment identifier.

4. The method of claim 3, wherein said assessment identifier comprises at least one of:
an assessment topic;
an assessment sub-topic;
an assessment level;
a knowledge goal; and
a knowledge self-assessment.

5. The method of claim 3, wherein said step of presenting a test comprises:
dynamically creating said test from said electronic archive in correspondence with a predetermined test creation rule, said predetermined test creation rule configured to enable a correlation between a test characteristic and one of said user identification and said assessment identifier.

6. The method of claim 5, wherein said test characteristic comprises:
a test duration;
a number of questions;
a test difficulty level;
a question sequence; and
a question grouping.

7. The method of claim 5, wherein said step of presenting a test comprises:
incorporating said stem question and one of said stem formula, said stem question range, said stem question variable, and said stem question constant into said test in correspondence with a predetermined question selection rule, said predetermined question selection rule configured to enable a correlation between said stem question and said user identification and said assessment identifier.

8. The method of claim 7, wherein said predetermined question selection rule is further configured to enable a correlation between said user identification and a previous test result.

9. The method of claim 7, wherein said predetermined question selection rule is further configured to enable a correlation between said user identification and another question presented during a previous test.

10. The method of claim 2, further comprising:
evaluating an answer to one of said dynamic question and said static question to create said assessment; and
providing one of said assessment and a recommendation to one of a test taker, a test creator, an employee manager, and a vendor, said recommendation corresponding to said assessment.

11. The method of claim 10, wherein said step of providing one of said assessment and a recommendation comprises:
providing said recommendation based on a predetermined recommendation selection rule, said predetermined recommendation rule configured to enable a correlation between an answer provided in response to said dynamic question to said recommendation.

12. The method of claim 5, further comprising:
creating said predetermined test creation rule; and
storing said predetermined test creation rule in said electronic archive.

13. The method of claim 7, further comprising:
creating said predetermined question selection rule; and
storing said predetermined question selection rule in said electronic archive.

14. The method of claim 11, further comprising:
creating said predetermined recommendation selection rule; and
storing said predetermined recommendation selection rule in said electronic archive.

15. The method of claim 1, further comprising:
creating said stem question and one of said stem formula, said stem question range, said stem question variable, and said stem question constant; and
storing said stem question and one of said stem formula, said stem question range, said stem question variable, and said stem question constant in said electronic archive.

16. The method of claim 11, wherein said step of providing said recommendation based on a predetermined recommendation selection rule comprises:
providing a recommendation to purchase a product.

17. The method of claim 16, further comprising:
receiving and storing payment information.

18. The method of claim 10, further comprising:
storing said answer to one of said dynamic question and said static question in the electronic archive.

19. The method of claim 1, wherein
said step of receiving a request for said assessment includes receiving a request for a group assessment and a group identifier; and
said step of presenting a test corresponding to said requested assessment includes presenting a group assessment comprising a plurality of assessments, each of said plurality of assessments including one of
a unique stem question,
a common stem question,
a common stem question range,
a common stem question variable, and
a common stem question constant.

20. A system configured to perform an assessment, comprising:
an input;
a processor connected to said input; and
a memory connected to one of said input and said processor, wherein said processor is configured to
receive a request for said assessment;
present a test corresponding to said requested assessment; and
derive a dynamic question for inclusion from said memory for inclusion in said test, said dynamic question including a stem question and one of a stem question formula, a stem question range, a stem question variable, and a stem question constant.

21. The system of claim 20, wherein said test also includes a static question.

22. The system of claim 20, wherein said processor is further configured to receive and store a user identification and an assessment identifier.

23. The system of claim 22, wherein said assessment identifier comprises at least one of:
an assessment topic;
an assessment sub-topic;
an assessment level;
a goal; and
a self-assessment.

24. The system of claim 22, wherein said processor is further configured to dynamically create said test from said memory in correspondence with a predetermined test creation rule, said predetermined test creation rule configured to enable a correlation between a test characteristic and one of said user identification and said assessment identifier.

25. The system of claim 24, wherein said test characteristic comprises:
a test duration;
a number of questions;
a test difficulty level;
a question sequence; and
a question grouping.

26. The system of claim 24, wherein said processor is further configured to incorporate said stem question and one of said stem formula, said stem question range, said stem question variable, and said stem question constant into said test in correspondence with a predetermined question selection rule, said predetermined question selection rule configured to enable a correlation between said stem question and said user identification and said assessment identifier.

27. The system of claim 26, wherein said predetermined question selection rule is further configured to enable a correlation between said user identification and a previous test result.

28. The system of claim 26, wherein said predetermined question selection rule is further configured to enable a correlation between said user identification and another question presented during a previous test.

29. The system of claim 21, said processor further configured to
evaluate an answer to one of said dynamic question and said static question to create said assessment; and
provide one of said assessment and a recommendation to one of a test taker, a test creator, an employee manager, and a vendor, said recommendation corresponding to said assessment.

30. The system of claim 29, wherein said processor is further configured to provide said recommendation based on a predetermined recommendation selection rule, said predetermined recommendation rule configured to enable a correlation between an answer provided in response to said dynamic question to said recommendation.

31. The system of claim 24, said processor further configure to:
create said predetermined test creation rule; and
store said predetermined test creation rule in said memory.

32. The system of claim 26, said processor further configured to:
create said predetermined question selection rule; and
store said predetermined question selection rule in said memory.

33. The system of claim 30, said processor further configured to:
create said predetermined recommendation selection rule; and
store said predetermined recommendation selection rule in said memory.

34. The system of claim 20, said processor further configured to:
create said stem question and one of said stem formula, said stem question range, said stem question variable, and said stem question constant; and
store said stem question and one of said stem formula, said stem question range, said stem question variable, and said stem question constant in said memory.

35. The system of claim 30, said processor further configured to provide a recommendation to purchase a product.

36. The system of claim 35, said processor further configured to receive and store payment information.

37. The system of claim 29, said processor further configured to store said answer to one of said dynamic question and said static question in the memory.

38. The system of claim 20, said processor further-configured to
receive a request for a group assessment and a group identifier; and
present a group assessment comprising a plurality of assessments, each of said plurality of assessments including one of
a unique stem question,
a common stem question,
a common stem question range,
a common stem question variable, and
a common stem question constant.

39. A computer program product configured to host instructions configured to enable a processor to
receive a request for said assessment; and
present a test corresponding to said requested assessment;
derive a dynamic question for inclusion from a memory for inclusion in said test, said dynamic question including a stem question and one of a stem question formula, a stem question range, a stem question variable, and a stem question constant.

40. The computer program product of claim 39, wherein said test also includes a static question.

41. The computer program product of claim 39, further comprising instructions configured to enable the processor to receive and store a user identification and an assessment identifier.

42. The computer program product of claim 41, wherein said assessment identifier comprises at least one of:
an assessment topic;
an assessment sub-topic;
an assessment level;
a goal; and
a self-assessment.

43. The computer program product of claim 41, further comprising instructions configured to enable the processor to
dynamically create said test from said memory in correspondence with a predetermined-test creation rule, said predetermined test creation rule configured to enable a correlation between a test characteristic and one of said user identification and said assessment identifier.

44. The computer program product of claim 43, wherein said test characteristic comprises:
a test duration;
a number of questions;
a test difficulty level;
a question sequence; and
a question grouping.

45. The computer program product of claim 43, further comprising instructions configured to enable the processor to
incorporate said stem question and one of said stem formula, said stem question range, said stem question variable, and said stem question constant into said test in correspondence with a predetermined question selection rule, said predetermined question selection rule configured to enable a correlation between said stem question and said user identification and said assessment identifier.

46. The computer program product of claim 45, wherein said predetermined question selection rule is further configured to enable a correlation between said user identification and a previous test result.

47. The computer program product of claim 45, wherein said predetermined question selection rule is further configured to enable a correlation between said user identification and another question presented during a previous test.

48. The computer program product of claim 40, further comprising instructions configured to enable the processor to
evaluate an answer to one of said dynamic question and said static question to create said assessment; and
provide one of said assessment and a recommendation to one of a test taker, a test creator, an employee manager, and a vendor, said recommendation corresponding to said assessment.

49. The computer program product of claim 48, further comprising instructions configured to enable the processor to provide said recommendation based on a predetermined recommendation selection rule, said predetermined recommendation rule configured to enable a correlation between an answer provided in response to said dynamic question to said recommendation.

50. The computer program product of claim 43, further comprising instructions configured to enable the processor to
create said predetermined test creation rule; and
store said predetermined test creation rule in said memory.

51. The computer program product of claim 45, further comprising instructions configured to enable the processor to
create said predetermined question selection rule; and
store said predetermined question selection rule in said memory.

52. The computer program product of claim 49, further comprising instructions configured to enable the processor to
create said predetermined recommendation selection rule; and
store said predetermined recommendation selection rule in said memory.

53. The computer program product of claim 39, further comprising instructions configured to enable the processor to
create said stem question and one of said stem formula, said stem question range, said stem question variable, and said stem question constant; and
store said stem question and one of said stem formula, said stem question range, said stem question variable, and said stem question constant in said memory.

54. The computer program product of claim 49, further comprising instructions configured to enable the processor to provide a recommendation to purchase a product.

55. The computer program product of claim 54, further comprising instructions configured to enable the processor to
receive and store payment information.

56. The computer program product of claim 48, further comprising instructions configured to enable the processor to
store said answer to one of said dynamic question and said static question in the memory.

57. The computer program product of claim 39, further comprising instructions configured to enable the processor to
receive a request for a group assessment and a group identifier; and
present a group assessment comprising a plurality of assessments, each of said plurality of assessments including one of
a unique stem question,
a common stem question,
a common stem question range,
a common stem question variable, and
a common stem question constant.
